(19) United States
(12) Patent Application Publication
(10) Pub. No.: US 2014/0095423 A1
(43) Pub. Date: Apr. 3, 2014

(54) INFERING TRAVEL PATH IN PUBLIC TRANSPORTATION SYSTEM

(71) Applicant: INTERNATIONAL BUSINESS MACHINES CORPORATION, Armonk, NY (US)

(72) Inventors: Ning Duan, Shanghai (CN); Xiang Fei, Beijing (CN); Peng Gao, Beijing (CN); Min Gong, Shanghai (CN); Ke Hu, Beijing (CN); Yun Jie Qiu, Shanghai (CN); Zhi Hu Wang, Beijing (CN); Xin Zhang, Beijing (CN)

(73) Assignee: INTERNATIONAL BUSINESS MACHINES CORPORATION, Armonk, NY (US)

(21) Appl. No.: 14/063,731

(22) Filed: Oct. 25, 2013

Related U.S. Application Data
(63) Continuation of application No. 14/038,321, filed on Sep. 26, 2013.

(30) Foreign Application Priority Data
Sep. 29, 2012 (CN) 201210379565.6

(51) Int. Cl. G06N 5/04

(52) U.S. Cl. CPC G06N 5/04
USPC 706/46

(57) ABSTRACT

A method and apparatus are disclosed for inferring a travel path in a public transportation system. The apparatus comprises: a single-line origin-destination (OD) inferring device configured to infer from boarding data of a bus line a passenger alighting stop on the line as an inferred passenger alighting stop according to historical data, wherein the boarding data comprises a passenger boarding stop during a predetermined time period and a number of boarding passengers at the stop. A transfer line inferring device is configured to infer a passenger transfer line as an inferred passenger transfer line according to the boarding data and the inferred passenger alighting stop obtained by the single-line OD inferring means.

### RELATED APPLICATION DATA

This application is a Continuation application of co-pending U.S. patent application Ser. No. 14/038,321 filed on Sep. 26, 2013, incorporated herein by reference in its entirety.

### BACKGROUND

The present invention relates to urban public transportation services, and more specifically, to predicting a travel path in the public transportation system for planning bus lines.

In modern cities, there is a growing demand for public transportation services. An objective of public transportation services is to safely transport passengers to destinations in a convenient and rapid manner. To this end, it is necessary to plan bus lines well. A main approach to planning bus lines is to form a transportation network by transfer stops. If a passenger is headed for a destination from an origin, whereas there is no through bus between the origin and the destination, then the passenger may take a bus of one line to a transfer stop, transfer at the transfer stop to a bus of another line, and finally arrive at the destination after one or more transfers. For the passenger, it is beneficial if there is a through bus from the origin to the destination. In fact, every bus passenger has a similar demand. For public transportation service providers, however, they need to know the number of passengers destined from place A towards place B before arranging through buses between A and B. Usually the number of passengers from origin A to destination B is represented by origin-destination pairs <A, B>, i.e., OD pairs <A, B>. It is an important problem for public transportation service providers to obtain OD pairs <A, B> of any two places A and B.

In the prior art, there has been proposed a method for predicting OD in different time periods on a single bus line. However, this method requires the number of boarding passengers and the number of alighting passengers at a bus stop; moreover, considering the transfer behavior of passengers, information being provided by predicting OD on a single bus line is rather limited.

### SUMMARY

Various embodiments of the present invention are intended to provide an improved method of inferring a travel path of a passenger.

According to one aspect of the present invention, there is provided an apparatus for inferring a travel path in a public transportation system, comprising: single-line origin-destination (OD) inferring means configured to infer, from boarding data of a bus line, a passenger alighting stop on the line as an inferred passenger alighting stop according to historical data, wherein the boarding data comprises a passenger boarding stop during a predetermined time period and a number of boarding passengers at the stop; and transfer line inferring means configured to infer a passenger transfer line as an inferred passenger transfer line according to the boarding data and the inferred passenger alighting stop obtained by the single-line OD inferring means.

According to another aspect of the present invention, there is provided a method of inferring a travel path in a public transportation system, comprising: (a) a single-line origin-destination (OD) inferring step of inferring, from boarding data of a bus line, a passenger alighting stop on the line as an inferred passenger alighting stop according to historical data, wherein the boarding data comprises a passenger boarding stop during a predetermined time period and a number of boarding passengers at the stop; and (b) a transfer line inferring step of inferring a passenger transfer line as an inferred passenger transfer line according to the boarding data and the inferred passenger alighting stop obtained in the single-line OD inferring step.

The various embodiments of the present invention may be used for OD inference between various stops in an area.

### BRIEF DESCRIPTION OF THE SEVERAL VIEWS OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 shows a block diagram of an exemplary computer system/server 12 which is applicable to implement the embodiments of the present invention;

FIG. 2 shows a block diagram of an apparatus for inferring a travel path in a public transportation system according to one embodiment of the present invention;

FIGS. 3A to 3C schematically show distribution of multiple bus lines in the public transportation system;

FIG. 4A schematically shows a flowchart of a method of inferring a travel path in a public transportation system according to one embodiment of the present invention; and

FIG. 4B schematically shows a flowchart of a method of inferring a travel path in a public transportation system according to another embodiment of the present invention.

### DETAILED DESCRIPTION

Some preferable embodiments will be described in more detail with reference to the accompanying drawings, in which the preferable embodiments of the present disclosure have been illustrated. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated data signal may take any of a variety of forms, including, but not limited to, an electro-magnetic signal, optical signal, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instruction means which implements the function/act specified in the flowchart and/or block diagram block or blocks.

The computer program instructions may also be loaded onto a computer, other programmable data processing apparatus, or other devices to cause a series of operational steps to be performed on the computer, other programmable data processing apparatus or other devices to produce a computer implemented process such that the instructions which execute on the computer or other programmable apparatus provide processes for implementing the functions/acts specified in the flowchart and/or block diagram block or blocks.

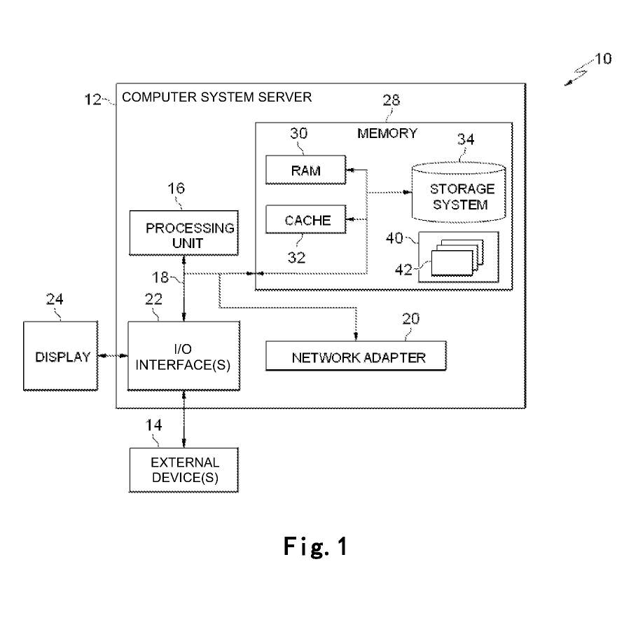

Referring now to FIG. 1, in which a block diagram of an exemplary computer system/server 12 which is applicable to implement the embodiments of the present invention is shown. Computer system/server 12 shown in FIG. 1 is only illustrative and is not intended to suggest any limitation as to the scope of use or functionality of embodiments of the invention described herein.

As shown in FIG. 1, computer system/server 12 is shown in the form of a general-purpose computing device. The components of computer system/server 12 may include, but are not limited to, one or more processors or processing units 16, a system memory 28, and a bus 18 that couples various system components including the system memory 28 and the processing units 16.

Bus 18 represents one or more of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown in FIG. 1 and typically called a “hard drive”). Although not shown in FIG. 1, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each drive can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

A method for inferring a travel path in a public transportation system in the present invention may be executed on computer system 100 shown in FIG. 1.

A general concept of the present invention is to infer, by synthetically applying single-line OD inference and transfer line inference, a travel path of a passenger in the public transportation system, thereby inferring OD of the complete travel path of the passenger.

With reference to the figures, illustration is presented below to the various embodiments of the present invention.

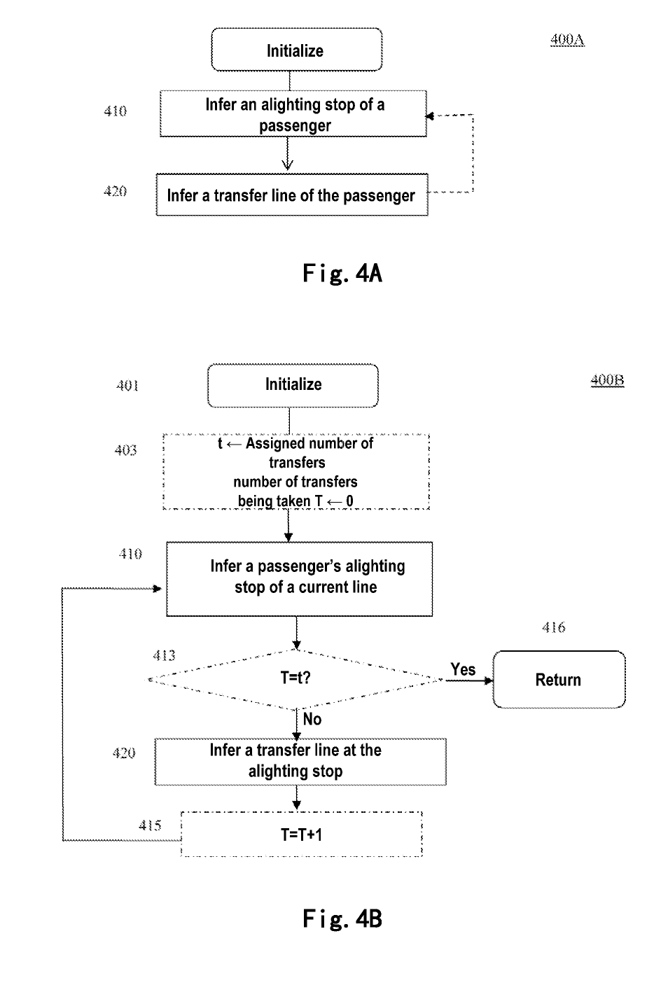

With reference to FIG. 4, this figure schematically shows a block diagram of an apparatus for inferring a travel path in a public transportation system according to one embodiment of the present invention.

Generally speaking, the embodiment of an apparatus for inferring a travel path in a public transportation system as shown in FIG. 4 comprises single-line origin-destination (OD) inferring means 210 and transfer line inferring means 220.

Single-line OD inferring means 210 is configured to infer, from boarding data of a bus line, a passenger alighting stop on the line as an inferred passenger alighting stop according to historical data, wherein the boarding data comprises a passenger boarding stop during a predetermined time period and the number of boarding passengers at the stop.

Transfer line inferring means 220 is configured to infer a passenger transfer line as an inferred passenger transfer line according to the boarding data on the single line (e.g. Bus No. 100) and the inferred passenger alighting stop obtained from single-line OD inferring means 210.

By using the inferred passenger transfer line as a single line and further applying single-line OD inferring means 210, a passenger alighting stop on this transfer line may be inferred, and so on and so forth, the passenger's final transfer line and alighting stop on the final transfer line may be inferred. A path from the passenger's initial boarding stop to the inferred alighting stop on the final transfer line constitutes a travel path in the public transportation system, and the initial origin and the final destination of the travel path are the inferred passenger origin and destination.

With reference to the figures, further illustration is presented below to the implementation of single-line OD inferring means 210.

According to one embodiment of the present invention, the single-line OD inferring means 210 comprises: an alighting probability calculator 211 and an alighting stop assigner 213.

Alighting probability calculator 211 is configured to calculate, according to passenger behavior analysis data 214, probabilities that the passenger alights at various stops. Alighting stop assigner 213 is configured to assign an alighting stop to the passenger as an inferred passenger alighting stop according to the probabilities that the passenger alights at various stops as calculated by alighting probability calculator 211.

By taking the up run of Bus No. 100 as an example of a single line, illustration is presented below to operations of single-line OD inferring means 210.

As input, single-line OD inferring means 210 obtains boarding data on the up run of Bus No. 100. Here, the boarding data comprises a boarding stop during a predetermined time period and the number of passengers boarding at this stop, e.g. the number of passengers boarding at respective stops A, B, C, D, E, F, G and H on the up run of Bus No. 100 from 7:00 to 9:00.

Passenger boarding data may be obtained in various manners, including, without limitation, obtaining boarding data from a card reader disposed on the bus.

Single-line OD inferring means 210 infers from the boarding data passenger alighting stops on the single line as inferred passenger alighting stops according to historical data. For example, if passenger X boards at stop C, it may be inferred he/she will alight at one of stops D, E, F, G and H.

Any existing solution in the prior art may be used to infer, from boarding data, passenger alighting stops on the single line according to historical data.

According to one embodiment of the present invention, passenger alighting stops on the single line may be inferred from the boarding data according to passenger behavior analysis data analyzed from historical data. Thus, said single-line OD inferring means 210 comprises an alighting probability calculator 211 and an alighting stop assigner 213. Alighting probability calculator 211 is configured to calculate, according to passenger behavior analysis data 214, probabilities that a passenger alights at various stops. Alighting stop assigner 213 is configured to assign an alighting stop to the passenger as an inferred passenger alighting stop according to the probabilities that the passenger alights at various stops as calculated by alighting probability calculator 211.

According to one embodiment of the present invention, the passenger behavior analysis data 214 comprises one or more of: tidal passenger flow data 214_1; taken stop number probability distribution 214_2.

As is well known, the bus passenger flow has tide-like characteristics. For example, at a certain stop there are many boarding passengers at the morning peak and many alighting passengers at the evening peak, and moreover, the number of boarding passengers in a specific time period at the morning peak and the number of alighting passengers in a specific time period at the evening peak have a stable direct proportion relationship. The term “tidal passenger flow data” refers to the number of passengers boarding at various stops in a corresponding time period in an opposite direction of a direction of a current line, which may be obtained from historical data. For example, stops on the down run of Bus No. 100 are (H, G, F, E, D, C, B, A) in this order, and in the time period between 17:00 and 19:00 the number of passengers at stops D, E, F, G, H are 20, 10, 30, 20, 20 respectively, just as shown in Table 1-1.

TABLE 1-1

| | Stop | | | | |
|---|---|---|---|---|---|
| | D | E | F | G | H |
| Down-run boarding | 20 | 10 | 30 | 20 | 20 |
| passengers | | | | | |

In case that passenger behavior analysis data 214 comprises tidal passenger flow data only, alighting probability calculator 211 calculates probabilities that passenger X boarding at stop C alights at stops D, E, F, G, H during the time period between 7:00 and 9:00, according to Table 1-1, just as shown in Table 1-2.

TABLE 1-2

| | Stop | | | | |
|---|---|---|---|---|---|
| | D | E | F | G | H |
| Alighting | 0.2 | 0.1 | 0.3 | 0.2 | 0.2 |
| probability P1 | | | | | |

Table 1-2 indicates that probabilities P1 that passenger X alights at stops D, E, F, G, H are 0.2, 0.1, 0.3, 0.2, 0.2 respectively, denoted by P1(D)=0.2, . . . .

The number of stops which a passenger taking a bus has passed since boarding until alighting conforms to a certain probability distribution, and the term “taken stop number probability distribution” refers to such probability distribution. For data of taken stop number probability distribution, they may be derived by analyzing historical data.

For example, taken stop number probability distribution of Bus No. 100 is as shown in Table 2-1 below.

TABLE 2-1

| taken stop number | 1 | 2 | 3 | 4 | 5 | . . . |
|---|---|---|---|---|---|---|
| Alighting | 10% | 15% | 40% | 20% | 5% | . . . |
| probability | | | | | | |

Table 2-1 indicates that probabilities of taking 1 stop, 2 stops, 3 stops, 4 stops and 5 stops on Bus No. 100 are 10%, 15%, 40%, 20%, 5% respectively, . . . .

Where passenger behavior analysis data 214 comprises taken stop number probability distribution only, alighting probability calculator 211 calculates probabilities that passenger X boarding at stop C alights at stops D, E, F, G, H according to the taken stop number probability distribution as shown in Table 2-2.

TABLE 2-2

| | Stop | | | | |
|---|---|---|---|---|---|
| | D | E | F | G | H |
| Interval stop | 1 | 2 | 3 | 4 | 5 |
| with stop C | | | | | |
| Alighting | 0.1 | 0.15 | 0.4 | 0.2 | 0.15 |
| probability P2 | | | | | |

Table 2-2 indicates that probabilities P2 that passenger X alights at stops D, E, F, G, H are 0.1, 0.15, 0.4, 0.2, 0.15 respectively, denoted by P2(D)=0.1, . . . .

According to one embodiment of the present invention, single-line origin-destination (OD) inferring means 210 may further comprise a weight setter 215. For example, where both tidal passenger flow data and taken stop number probability distribution are used, the weight setter is for setting a weight of the tidal passenger flow data and a weight of the taken stop number probability distribution for transfer line probability calculator 211.

For example, suppose a weight of tidal passenger flow data is w1=2 and a weight of taken stop number probability distribution is w2=1, then alighting probability calculator 211 calculates probabilities that passenger X boarding at stop C alights at stops D, E, F, G, H from the probability data shown in Table 2-1 and Table 2-2, by using Equation P3=(P1*w1+P2*w2)/(w1+w2), just as shown in Table 3.

TABLE 3

| | Stop | | | | |
|---|---|---|---|---|---|
| | D | E | F | G | H |
| P1 | 0.2 | 0.1 | 0.3 | 0.2 | 0.2 |
| P2 | 0.1 | 0.15 | 0.4 | 0.2 | 0.15 |
| P3 | 0.17 | 0.12 . . . | 0.33 . . . | 0.2 . . . | 0.18 |

Various embodiments include that alighting probability calculator 211 calculates probabilities a passenger boarding at stop C alights at various stops according to passenger behavior analysis data 214 have been described above by taking the passenger boarding at stop C as an example.

Alighting probability calculator 211 may further calculate probabilities a passenger boarding at any other stop than stop C alights at various stops according to passenger behavior analysis data 214, in a similar way as described above, which is not detailed here.

Probabilities the passenger alights at various stops as calculated by alighting probability calculator 211 may be used by alighting stop assigner 213 for assigning an alighting stop to the passenger as an inferred passenger alighting stop.

For example, take probabilities P3 that a passenger boarding at stop C alights at stops D, E, F, G, H as shown in Table 3 as an example only, alighting stop assigner 213 may randomly assign an alighting stop to each passenger boarding at stop C as an inferred passenger alighting stop according to the probability distribution shown in Table 3. Obviously, regarding all passengers boarding at stop C, the inferred passenger alighting stops, as a whole, conform to probabilities calculated by alighting probability calculator 211 that a passenger alights at various stops.

Likewise, alighting stop assigner 213 may randomly assign an alighting stop to each passenger as an inferred passenger alighting stop according to probabilities calculated by alighting probability calculator 211 that a passenger boarding at any other stop (e.g. stop D) than stop C alights at various stops, in a similar way as described above, which is not detailed here. Alighting stops assigned for a passenger boarding at any other stops than stop C are computed as the inferred passenger alighting stops. As a result, regarding all passengers boarding at all stops, the inferred passenger alighting stops, as a whole, conform to probabilities calculated by alighting probability calculator 211 that a passenger alights at various stops.

The implementation of single-line OD inferring means 210 has been illustrated above.

Next illustration is presented to implementation of transfer line inferring means 220.

According to one embodiment of the present invention, it is possible to infer a passenger transfer line as an inferred passenger transfer line according to passenger behavior analysis data which is obtained by analyzing the historical data, and according to the boarding data of passenger X on the single line and the inferred passenger alighting stop F obtained from single-line OD inferring means 210.

Thus, the transfer line inferring means 220 comprises a transfer line probability calculator 221 and a transfer line assigner 223. Transfer line probability calculator 221 is configured to calculate probabilities that a passenger transfers to various lines according to passenger behavior analysis data 224. Transfer line assigner 223 is configured to assign a transfer line to a passenger as an inferred passenger transfer line according to the probabilities calculated by transfer line probability calculator 221 that the passenger transfers to various lines.

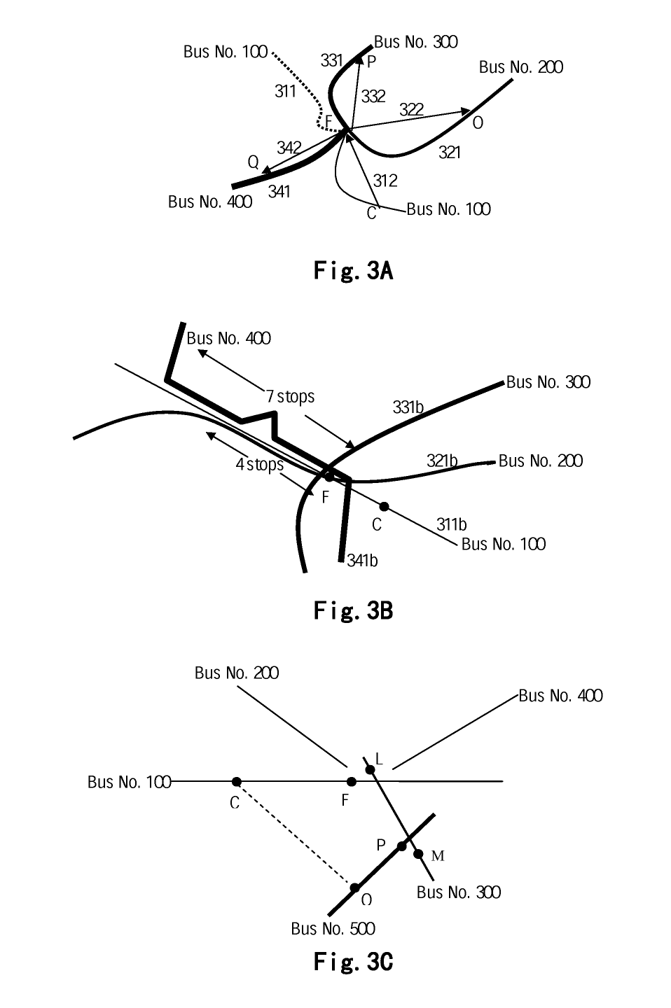

With reference to FIGS. 3A and 3B, illustration is presented to operations of transfer line inferring means 220 by taking passenger X boarding at stop C on the up run of Bus No. 100 as an example.

According to one embodiment of the present invention, the passenger behavior analysis data 224 may comprise: transfer angle constraint data 224_1. With reference to FIG. 3A, illustration is presented to implementation that transfer line inferring means 220 infers a passenger transfer line by using transfer angle constraint data.

FIG. 3A is a schematic view of distribution of multiple bus lines. FIG. 3A shows four bus lines: Bus No. 100, Bus No. 200, Bus No. 300 and Bus No. 400, which are represented by curves 311, 321, 331 and 341 respectively. FIG. 3A further illustrates two stops C and F of Bus No. 100, stop O of Bus No. 200, stop P of Bus No. 300 and stop Q of Bus No. 400.

As shown in FIG. 3A, suppose an inferred alighting stop of passenger X is F, a transfer stop set S(F)=(Bus No. 200, Bus No. 300, Bus No. 400), i.e. transfer lines around stop F are Bus No. 200, Bus No. 300 and Bus No. 400.

The term “transfer angle” refers to an included angle between a line direction before transfer and a line direction after transfer. As shown in FIG. 3A, the line direction before transfer is as shown by an arrow 312. If Bus No. 200 is transferred to, then the line direction after transfer is as shown by an arrow 322. In this case, the transfer angle is an included angle between arrow 312 and arrow 322, or denoted by “transfer angle CFO.” Similarly, arrows 332 and 342 in FIG. 3A represent line directions after transferring to Bus No. 300 and Bus No. 400, respectively.

The transfer angle constraint data refers to data regarding impact of a transfer angle on passenger transfer behavior which is obtained from passenger behavior analysis of historical data, e.g., transfer line attraction function.

Where passenger behavior analysis data 224 comprises transfer angle constraint data only, transfer line probability calculator 221 calculates probabilities that a passenger transfers to various lines in the following steps.

1. For each line in the transfer line set, using single-line OD inferring means 210 to infer where the passenger will alight if the passenger transfers to that line. For example, first possible alighting stops on the three lines are inferred using single-line OD inferring means 210, which are supposed to be stop O of Bus No. 200, stop P of Bus No. 300 and stop Q of Bus No. 400.

2. Calculating an included angle of the last line's boarding stop—alighting stop—transfer line's alighting stop, i.e., transfer angle T_angle. For example, according to inferred stop O of Bus No. 200, stop P of Bus No. 300 and stop Q of Bus No. 400, three transfer angles CFO=80°, CFP=170° and CFQ=70° are calculated.

3. Calculating attraction of each transfer line according to transfer angle constraint data and transfer angle. For example, attraction of each transfer line is calculated according to a transfer line attraction function and a transfer angle. As described above, the transfer line attraction function is an empirical formula obtained from passenger behavior analysis of historical data and is a function of transfer angle, e.g., may be expressed as:

Acc=10+0.1*(T_angle−90°)

Where Acc denotes attraction of a transfer line, according to the formula, it may be calculated that attractions of Bus No. 200, Bus No. 300 and Bus No. 400 each as a transfer line are equal to 9, 18 and 8 respectively.

4. Calculating probabilities the passenger transfers to various lines according to the attractions of the transfer lines. In this example, the probability of transferring to Bus No. 200 is 9/(9+18+8)=9/35, and probabilities of transferring to Bus No. 300 and Bus No. 400 are 18/35 and 8/35 respectively.

Process and result described above are as shown in Table 4.

TABLE 4

| | Transfer Line | | |
|---|---|---|---|
| | 200 | 300 | 400 |
| Inferred Alighting Stop | O | P | Q |
| Transfer Angle T_angle | CFO = 80° | CFP = 170° | CFQ = 70° |
| Attraction Acc | 9 | 18 | 8 |
| Transfer Probability P4 | 9/35 | 18/35 | 8/35 |

Transfer line assigner 223 may randomly assign a transfer line to passenger X inferred to alight at stop F as an inferred transfer line of passenger X, according to transfer probabilities P4.

Illustration is presented below to how transfer line probability calculator 221 calculates probabilities the passenger transfers to various lines where passenger behavior analysis data 224 comprises transfer angle constraint data only.

According to one embodiment of the present invention, the passenger behavior analysis data 224 may comprise: similarity constraint data 224_2. With reference to FIG. 3B, illustration is presented below to implementation that transfer line inferring means 220 infers a passenger transfer line by using similarity constraint data.

FIG. 3B schematically shows distribution of bus stops of four bus lines Bus No. 100, Bus No. 200, Bus No. 300 and Bus No. 400. As shown in this figure, curves 311b, 321b, 331b and 341b represent bus stops of Bus No. 100, Bus No. 200, Bus No. 300 and Bus No. 400, respectively.

The term “similarity” refers to common-line stops starting from a certain stop of two bus lines. As shown in FIG. 3B, for passenger X boarding at stop C on bus line 311b of Bus No. 100, an inferred alighting stop is stop F. Starting from stop F, bus line 311b of Bus No. 100 has different numbers of common-line stops with bus lines of Bus No. 200, Bus No. 300 and Bus No. 400, i.e., 4 common-line stops with bus line 321b of Bus No. 200, 0 common-line stop with bus line 331b of Bus No. 300 and 7 common-line stops with bus line 341b of Bus No. 400. Thus, similarities Sim of Bus No. 100 with Bus No. 200, Bus No. 300 and Bus No. 400 are 4, 0 and 7 respectively.

The similarity constraint data refers to data regarding impact of similarity on passenger transfer behavior and obtained from passenger behavior analysis of historical data, e.g. a similarity evaluation rule.

Transfer line probability calculator 221 calculates probabilities that the passenger transfers to various lines according to similarity constraint data and similarity, e.g., calculates probabilities that the passenger transfers to various lines according to a predetermined similarity evaluation rule. As described above, the similarity evaluation rule is an empirical rule obtained from passenger behavior analysis of historical data and is a function of similarity, e.g., may be expressed as:

P=10−Sim

Where P denotes a probability of transferring, according to the formula, it may be calculated that probabilities of transferring at stop F to Bus No. 200, Bus No. 300 and Bus No. 400 are respectively 6, 10 and 13 or 6/19, 10/19 and 3/19, the latter being a result from normalizing the three values of 6, 10 and 13.

Process and result described above are as shown in Table 5.

TABLE 5

| | Transfer Line | | |
|---|---|---|---|
| | 200 | 300 | 400 |
| Common-Line Stops | 4 | 0 | 7 |
| Transfer Probability P5 | 6/19 | 10/19 | 3/19 |

Transfer line assigner 223 may randomly assign a transfer line to passenger X inferred to alight at stop F as an inferred transfer line of passenger X, according to transfer probabilities P5.

Description has been presented above to operations that transfer line probability calculator 221 calculates probabilities the passenger transfers to various lines where passenger behavior analysis data 224 comprises transfer angle constraint data or similarity constraint data only.

According to one embodiment of the present invention, transfer line probability calculator 221 may further comprise a weight setter 225. For example, where both transfer angle constraint data and similarity constraint data are used, the weight setter 225 is used for setting a weight of transfer angle constraint data and a weight of similarity constraint data for transfer line probability calculator 221.

For example, suppose a weight of transfer angle constraint data is w3=1 and a weight of similarity constraint data is w4=2, then transfer line probability calculator 211 calculates probabilities that passenger X transfers at stop F to Bus No. 200, Bus No. 300 and Bus No. 400 according to the probability data shown in Table 4 and Table 5, P6=(P4*w3+P5*w4)/(w3+w4)=(P4+P5*2)/3, just as shown in Table 6.

TABLE 6

| | Transfer Line | | |
|---|---|---|---|
| | | | Bus No. |
| | Bus No. 200 | Bus No. 300 | 400 |
| Transfer Probability P4 | 09/35 | 18/35 | 8/35 |
| Transfer Probability P5 | 6/19 | 10/19 | 3/19 |
| Weighted Transfer Probability P6 | 0.3 | 0.52 | 0.18 |

Values 0.3, 0.52 and 0.18 of weighted transfer line probability P6 in Table 6 are normalized values of the weighted probability of transfer line Bus No. 200, Bus No. 300 and Bus No. 400, respectively. Transfer line assigner 223 may randomly assign a transfer line to passenger X inferred to alight at stop F as an inferred transfer line of passenger X according to transfer probability P6.

By taking passenger X boarding at stop C as an example, description has been presented above to various embodiments that transfer line probability calculator 221 calculates probabilities of transferring at passenger X's inferred alighting stop F to various lines according to passenger behavior analysis data 224.

Transfer line probability calculator 221 may further calculate probabilities that the passenger alighting at any other stop than stop F transfers to various lines, in a similar way as described above, which is not detailed here.

Probabilities calculated by transfer line probability calculator 221 that the passenger transfers to various lines may be used by transfer line assigner 223 for assigning a transfer line to the passenger as an inferred passenger transfer line.

By taking for example normalized probabilities P6 as shown in Table 6 that the passenger alighting at stop F transfers to Bus No. 200, Bus No. 300 and Bus No. 400, transfer line assigner 223 may randomly assign a transfer line to each passenger inferred to alight at stop F as an inferred passenger transfer line according to probability distribution shown in Table 6. Obviously for all passengers alighting at stop F, inferred passenger transfer lines, as a whole, conform to probabilities calculated by transfer line probability calculator 221 that the passenger transfers to various lines.

Likewise, transfer line assigner 223 may randomly assign a transfer line to each passenger as an inferred passenger transfer line according to probabilities calculated by transfer line probability calculator 221 that the passenger alighting at any other stop than stop F transfers to various lines, in a similar way as described above, which is not detailed here. A transfer line assigned for the passenger alighting at any other stop than stop F is computed as the inferred passenger transfer line. As a result, regarding all passengers boarding at all stops, inferred passenger transfer lines, as a whole, conform to probabilities calculated by transfer line probability calculator 221 that the passenger transfers to various lines.

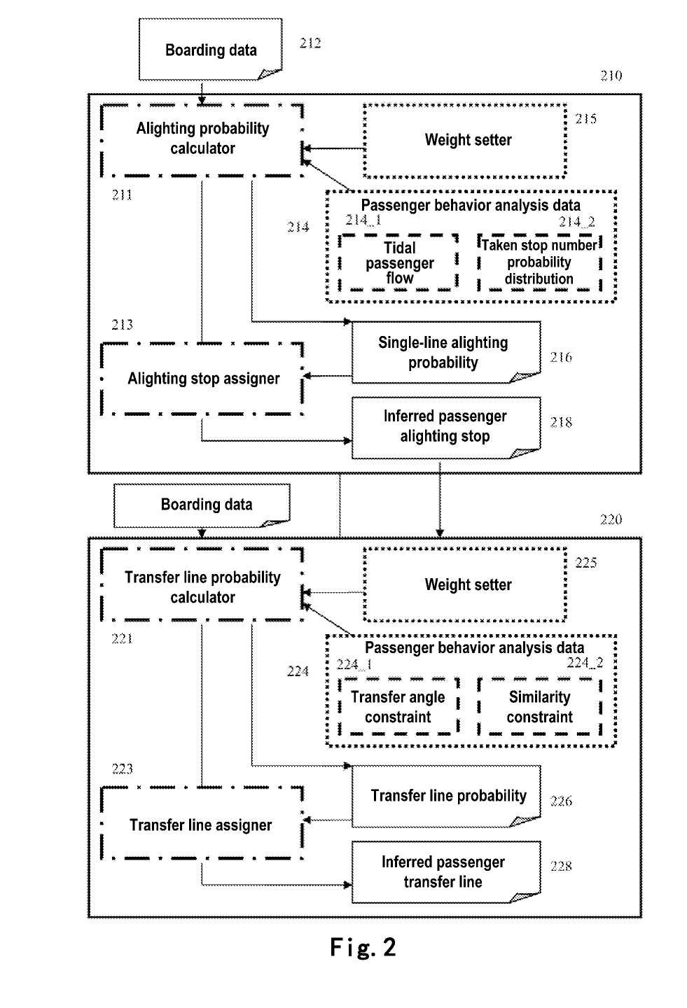

Various embodiments of the apparatus for inferring a travel path in a public transportation system according to the present invention has been illustrated above in conjunction with FIG. 2. Note FIG. 2 and its depiction are only illustrative rather than limiting. For example, in the figure passenger behavior analysis data 214 and passenger behavior analysis data 224 are separate from each other, whereas this is merely for the purpose of representation and illustration; obviously they may be integrated. Similarly, weight setter 215 and weight setter 225 may also be integrated as a component or integrated with passenger behavior analysis data. Therefore, those skilled in the art may make various apparent modifications or adaptations without changing the basic functionality of the apparatus shown in FIG. 2.

Under the same convention concept, the present invention further provides a method of inferring a travel path in the public transportation system, especially a method used in an apparatus for inferring a travel path in the public transportation system.

With reference to FIG. 4A, this figure shows a flowchart of a method of inferring a travel path in the public transportation system according to one embodiment of the present invention.

A process 400A of the method shown in FIG. 4A is a process proceeding with respect to one passenger, comprising two steps:

(a) a single-line origin-destination (OD) inferring step 410; and

(b) a transfer line inferring step 420.

In the single-line OD inferring step 410, a passenger alighting stop on a bus line is inferred, from boarding data of the line, as an inferred passenger alighting stop, wherein the boarding data comprises a passenger boarding stop during a predetermined time period and the number of boarding passengers at the stop. For example (refer to FIG. 3A), passenger X boards at stop C of the bus line of Bus No. 100, then it is inferred in step 410 that passenger X will alight at stop F.

Then, in transfer line inferring step 420, a passenger transfer line is inferred as an inferred passenger transfer line according to the boarding data on the single line and the inferred passenger alighting stop obtained in the single-line OD inferring step. For example, after it is inferred in step 410 that passenger X alights at stop F, it may further be inferred in step 420 that passenger X's transfer line is Bus No. 300.

According to one embodiment of the present invention, transfer line inferring step 420 comprises:

an alighting probability calculating step of calculating probabilities that the passenger alights at various stops according to passenger behavior analysis data; and an alighting stop assigning step of assigning an alighting stop to the passenger as an inferred passenger alighting stop according to the probabilities calculated in the alighting probability calculating step that the passenger alights at various stops.

According to one embodiment of the present invention, the passenger behavior analysis data comprises one or more of: tidal passenger flow data; taken stop number probability distribution.

According to one embodiment of the present invention, the method further comprises: setting for the alighting probability calculating step a weight of the tidal passenger flow data and a weight of the taken stop number probability distribution, respectively.

According to one embodiment of the present invention, transfer line inferring step 420 comprises:

a transfer line probability calculating step of calculating probabilities that the passenger transfers to various lines according to the passenger behavior analysis data; and a transfer line assigning step of assigning a transfer line to the passenger as an inferred passenger transfer line according to the probabilities calculated in the transfer line probability calculating step that the passenger transfers to various lines.

According to one embodiment of the present invention, the passenger behavior analysis data comprises one or more of: transfer angle constraint data; similarity constraint data.

According to one embodiment of the present invention, the method further comprises: setting for the transfer line probability calculating step a weight of the transfer angle constraint data and a weight of the similarity constraint data respectively.

With respect to a passenger, the above-illustrated method according to the various embodiments of the present invention infers an alighting stop on a line and the next transfer line, e.g., infers passenger X alights at stop F of Bus No. 100 and transfers to Bus No. 300.

In step 410, the passenger's alighting stop is inferred according to the passenger's boarding stop on a current line, the number of passengers boarding at the boarding stop as well as passenger behavior analysis data.

In step 420, the passenger's transfer line at an alighting stop is inferred according to the passenger behavior analysis data.

According to one embodiment of the present invention, the method shown in FIG. 4A further comprises:

(c) a transfer line OD inferring step of inferring the passenger's alighting stop according to passengers' boarding stops on transfer lines, a number of passengers boarding at the boarding stops as well as passenger behavior analysis data.

Step (c) is executed after step 420. In fact, step (c) corresponds to step 410, as shown by a dashed-line arrow in FIG. 4A. At this point, the current line in step 410 is the transfer line inferred in step 420. Therefore, step 410 corresponds to inferring the passenger's alighting stop according to the passenger's boarding stop on the transfer line, the number of passengers boarding at the boarding stop and the passenger behavior analysis data.

With reference to FIG. 3A, still continue the foregoing example. After it is inferred that passenger X transfers to Bus No. 300, step (c) further infers that passenger X alights at stop P of Bus No. 300. The implementation of this step is the same as that of step 410, except that the transfer line (e.g. Bus No. 300) is used as the bus line (e.g. Bus No. 100) in step 410.

Throughout the foregoing process, suppose the passenger takes only 1 transfer. In real life, however, passengers take different numbers of transfers. For example, some passengers do not take any transfer, while others have to take two or more transfers, which depends on different situations (e.g., in different cities). In a given city, transfers taken by passengers, as a whole, conform to certain probability distributions; such transfer number probability distributions may be obtained by means of historical data analysis, sampling survey, etc.

According to one embodiment of the present invention, where transfer number probability distribution can be obtained, process 400A shown in FIG. 4A may be extended, wherein before step 410, the number of transfers is assigned to the passenger according to the transfer number probability distribution; and after step 410, steps 420 and 410 are repeated according to the assigned number of transfers.

In other words, before step (a), the number of transfers is assigned to the passenger according to the transfer number probability distribution; after step (a), steps (b) and (c) are repeated according to the assigned number of transfers.

With reference to FIG. 4B, this figure is a flowchart of a method of inferring a travel path in a public transportation system according to another embodiment of the present invention. Steps 410 and 420 included in a process 400B shown in FIG. 4B function in the same way as steps 410 and 420 in FIG. 4A, and thus process 400B shown in FIG. 4B is an extension of process 400A shown in FIG. 4A.

Process 400B starts from step 401, which is a step of initialization, obtaining the number of boarding passengers W(L,S,T), i.e. the number of passengers boarding at stop S on line L in time period T.

Next in step 403, the number of transfers t (t>=0) is randomly assigned to the passenger according to the transfer number probability distribution, and the number of actual transfers T is zero-cleared.

If t=0, it indicates that a result of random assignment according to the transfer number probability distribution is the passenger will not transfer to other bus line; if t>1, it indicates that a result of random assignment according to the transfer number probability distribution is the passenger will transfer to other bus line(s) for t times.

The zero-clearing the number of actual transfers T indicates the passenger has no behavior of transferring to other bus line yet.

In step 410, the passenger's alighting stop is inferred according to the passenger's boarding stop at a current line, the number of passengers boarding at this stop as well as passenger behavior analysis data.

In step 413, it is judged whether the number of actual transfers T is equal to the assigned number of transfers t or not.

If yes, process 400 ends, as shown by numeral 410; otherwise, process 400 proceeds to step 420.

In step 420, the passenger's transfer line at the alighting stop is inferred.

Then, in step 415, the value of the number of actual transfers T is increased by 1. Afterwards, the process proceeds to step 410 of inferring the passenger's alighting stop. At this point, the current line is the transfer line inferred in step 420. Therefore, executing step 410 corresponds to inferring the passenger's alighting stop according to the passenger's boarding stop on the transfer line, the number of passengers boarding at the boarding stop as well as passenger behavior analysis data.

Schematic illustration is presented to a complete instance of executing one process 400B in conjunction with FIGS. 2 and 3C. FIG. 3C schematically shows distribution of multiple bus lines in the public transportation system, wherein there are shown five bus lines, Bus No. 100, Bus No. 200, Bus No. 300, Bus No. 400 and Bus No. 500, and stops C and F on Bus No. 100, stops L and M on Bus No. 300, as well as stops P and Q on Bus No. 500.

In this instance, process 400B comprises steps S1 to S8.

S1. (step 401) suppose W (100,C,[7:00,9:00]) passengers board at stop C on the up run of Bus No. 100 in the morning peak time period ([7:00,9:00]), following stop C are five stops D, E, F, G and H on the up run of Bus No. 100, then with respect to one passenger X boarding at stop C, it is inferred as below:

S2. (step 403), the number of transfers t=2 is randomly assigned to the passenger according to transfer number probability distribution, and number of actual transfers T is zero-cleared.

S3. (step 410), the passenger's alighting stop on the up run of Bus No. 100 is inferred, with a process as below:

S3_1) According to tidal passenger flow data 214_1, alighting probabilities are calculated according to the number of boarding passengers in a corresponding tidal time period (a time period corresponding to the morning peak [7:00,9:00], i.e. evening peak time period [17:00,19:00]) on the down run of Bus No. 100. Suppose the ratio of passengers boarding at D, E, F, G and H in the evening peak time period on the down run of Bus No. 100 is 2:1:3; 2:2, then according to tidal passenger flow data, the passenger's normalized probabilities P1 of alighting at D, E, F, G and H on the up run of Bus No. 100 are 0.2, 0.1, 0.3, 0.2, 0.2 (Table 1-2).

S3_2) Alighting probabilities are calculated according to taken stop number probability distribution 214. Suppose stop number distribution in the morning peak time period on the up run of Bus No. 100 is 1 stop, 2 stops, 3 stops, 4 stops and 5 stops, and a corresponding ratio of passengers is 10:15:40:20:15, then the passenger's normalized probabilities P2 of alighting at stops D, E, F, G and H on the up run of Bus No. 100 equal to 0.1:0.15:0.4:0.2:0.15 (Table 2-2);

S3_3) According to weight setter 215, suppose weights of tidal passenger flow data and taken stop number probability distribution are 2 and 1 respectively, then the passenger's fusion probabilities of alighting at D, E, F, G and H on the up run of Bus No. 100 are:

(0.2*2+0.1):(0.1*2+0.15):(0.3*2+0.4):(0.2*2+0.2):(0.2*2+0.15),

normalized to P3=0.17:0.12:0.33:0.2:0.18 (numeral 216);

S3_4) Alighting stop assigner 213 selects an alighting stop for passenger X in the form of probability random numbers according to alighting probabilities P3 (numeral 216) of various stops, e.g. stop F on Bus No. 100.

Then, steps 420 and 410 are repeated for t times. Since the number of transfers t=2 and the number of actual transfers T=0, steps 420 and 410 are repeated for t times, with a process as below:

The first transfer

S4. (step 420) suppose there are 3 lines around stop F, Bus No. 200, Bus No. 300 and Bus No. 400 (FIG. 3C),

S4_1) Transfer probabilities of 3 lines are calculated according to transfer angle constraint 224_1, and suppose a result is P4=9/35:18/35:8/35 (Table 4);

S4_2) Transfer probabilities of 3 lines are calculated according to similarity constraint 224_2, and suppose a result is P5=6/19:10/19: 3/19 (Table 5);

S4_3) Suppose weights configured by weight setter 225 for transfer angle constraint and similarity constraint are 1 and 2 respectively, then weighted probabilities P6=(9/35+2*6/19):(18/35+2*10/19):(8/35+2*3/19) or 0.3:0.52:0.18 (numeral 226, Table 6);

S4_4) A next transfer line is selected for passenger X in the form of probability random numbers according to transfer probabilities 226 of various lines by using transfer line assigner 223, e.g. it is inferred passenger X transfers to Bus No. 300, boarding at stop L;

S5. It is inferred by single-line alighting stop inference (step 410) in a similar way to S2 that the passenger alights at a stop of Bus No. 300, e.g. Stop M of Bus No. 300 (FIG. 3C).

The Second Transfer

S6. Transfer line inference (step 420) is executed in a similar way to S4 to infer the passenger's second transfer line at stop M, e.g. it is inferred the passenger transfers to Bus No. 500 boarding at stop P (FIG. 3C);

S7. (step 410) Single-line alighting stop inference (step 410) is executed in a similar way to S2 to infer the passenger's alighting stop of Bus No. 500, e.g. alights at stop Q of Bus No. 500 (FIG. 3C);

S8. Inference results are organized as below: passenger X's travel path is: boarding at stop C of Bus No. 100→alighting at stop F of Bus No. 100→transferring at stop L to Bus No. 300→alighting at stop M of Bus No. 300→transferring at stop P to Bus No. 500→alighting at stop Q of Bus No. 500, so passenger X's corresponding OD pair is <C, Q>.

Description has been presented above to various embodiments of the method of inferring a travel path in the public transportation system. Those skilled in the art should understand the result of the method may further be processed using various techniques in the prior art. Such a process is schematically illustrated below.

S9. The reasonability of the inferred travel path is verified. Take the above inferred OD pair <C, Q> of passenger X as an example. The reasonability of the path may be verified in the following way: searching for the optimal travel path set between the OD pair <C, Q>, if the inferred path exists in the optimal path set, indicating the passenger's inferred path is reasonable and OD inference succeeds; otherwise, repeating steps S2 to S8 until a reasonable path is inferred.

S10. With respect to all lines L, all time periods T and boarding passengers at all stops S, OD inference of S1 to S9 is repeated with input of W(L,S,T), and upon completion all passengers' inferred paths may be obtained.

S11. Fit the number of primary boarding passengers.

The number of primary boarding passengers refers to the number of passengers directly headed towards stop S of line L from an origin in the time period T, denoted by U(L,S,T). The number of transfer passengers refers to the number of passengers transferring at stop S to line L from other line in the time period T, denoted by V(L, S,T). The number of actual boarding passengers refers to the number of boarding passengers at stop S of line L in the time period T, denoted by W(L,S,T), which comprises the number of primary boarding passengers and the number of transferring passengers, and the single-line boarding data denoted by numeral 212 in FIG. 2 comprises W(L,S,T). In process 400B shown in FIG. 4B, initialization step 401 comprises initializing the number of primary boarding passengers U(L,S,T) and the number of transfer passengers V(L,S,T), i.e. with respect to all lines L, stops S and time periods T, let U(L,S,T)=W(L,S,T),V(L,S,T)=0.

The process of fitting the number of primary boarding passengers is the process of iterating steps S1 to S10. Below is schematic illustration.

S11_1. With respect to all passengers' inferred paths, the number of transfer passengers at each stop of each line is updated according to a transfer line and stop. For example, if passenger X's inferred travel path includes transfer stops, stop L of Bus No. 300 and stop P of Bus No. 500, then V(300,L, [7:00,9:00]+a) and V(200,P, [7:00,9:00]+a+b) each are increased by 1, wherein a is the average travel time at the morning peak from stop C to stop F of Bus No. 100, and b is the average travel time at the morning peak from stop L to stop M of Bus No. 300. Suppose a=30 minutes and b=15 minutes, then the number of transfer passengers may be denoted as V(300,L,[7:30,9:30]) and V(500,P, [7:45,9:45]) respectively;

Sl1_2. Evaluate error of the number of boarding passengers: suppose the number of transfer passengers boarding at stop L of Bus No. 300 V(300,L,[7:30,9:30]) is 50, the number of primary boarding passengers in current iteration U(300,L,[7:30,9:30]) is 100, and the number of actual boarding passengers in input data W(300,L, [7:30,9:30]) is 120, then error of the total number of boarding passengers at stop L of Bus No. 300 e (300,L,[7:30,9:30]) is (50+100)−120=30;

S11_3. Correct iteration: make statistics of the root mean square of error e(L,S,T) of the number of boarding passengers at all stops of all lines in all time periods; if the error value e reaches specified error margin, then stop iteration; otherwise correct the number of primary boarding passengers. For example, the number of primary boarding passengers at stop L of Bus No. 300 U(300,L,[7:30,9:30]) may be corrected as 100*(120/150)=80, and iteration of S1 to S10 is repeated.

After all lines, stops and time periods are subject to the foregoing process, inference results are organized: a final OD matrix may be obtained by summing up related numbers of passengers according to the OD pair.

Various embodiments of the method of inferring a travel path in the public transportation system of the present invention have been illustrated above. As detailed illustration has been provided to various embodiments of the apparatus for inferring a travel path in the public transportation system of the present invention, the illustration of various embodiments of the method of inferring a travel path in the public transportation system has ignored contents which duplicate or can be derived from the illustration of various embodiments of the apparatus for inferring a travel path in the public transportation system.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An apparatus for inferring a travel path in a public transportation system, comprising:
single-line origin-destination (OD) inferring means configured to infer, from boarding data of a bus line, a passenger alighting stop on the line as an inferred passenger alighting stop according to historical data, wherein the boarding data comprises a passenger boarding stop during a predetermined time period and a number of boarding passengers at the stop; and
transfer line inferring means configured to infer a passenger transfer line as an inferred passenger transfer line according to the boarding data and the inferred passenger alighting stop obtained by the single-line OD inferring means.

2. The apparatus according to claim 1, wherein the single-line OD inferring means comprises:
an alighting probability calculator configured to calculate probabilities that the passenger alights at various stops according to passenger behavior analysis data; and
an alighting stop assigner configured to assign an alighting stop to the passenger as an inferred passenger alighting stop according to the probabilities calculated by the alighting probability calculator that the passenger alights at various stops.

3. The apparatus according to claim 2, wherein the passenger behavior analysis data comprises one or more of:
tidal passenger flow data; and
taken stop number probability distribution.

4. The apparatus according to claim 3, further comprising a weight setter, wherein the weight setter is configured to set for the alighting probability calculator a weight of the tidal passenger flow data and a weight of the taken stop number probability distribution, respectively.

5. The apparatus according to claim 1, wherein the transfer line inferring means comprises:
a transfer line probability calculator configured to calculate probabilities that the passenger transfers to various lines according to passenger behavior analysis data; and
a transfer line assigner configured to assign a transfer line to the passenger as an inferred passenger transfer line according to the probabilities calculated by the transfer line probability calculator that the passenger transfers to various lines.

6. The apparatus according to claim 5, wherein the passenger behavior analysis data comprises one or more of:
transfer angle constraint data; and
similarity constraint data.

7. The apparatus according to claim 6, further comprising a weight setter, wherein the weight setter is used for setting for the transfer line probability calculator a weight of the transfer angle constraint data and a weight of the similarity constraint data, respectively.
